(19) United States
(12) Patent Application Publication
(10) Pub. No.: US 2009/0133575 A1
(43) Pub. Date: May 28, 2009

(54) METHOD FOR THE TREATMENT OF SORPTION MATERIAL IN THE PURIFICATION OF SMOKE GAS IN BRICKWORKS

(76) Inventor: Friedrich Hellmich, Kirchlengern (DE)

Correspondence Address: BARNES & THORNBURG LLP, 750-17TH STREET NW, SUITE 900, WASHINGTON, DC, 20006-4675, US

(21) Appl. No.: 12/275,684

(22) Filed: Nov. 21, 2008

(30) Foreign Application Priority Data
Nov. 27, 2007 (DE) 10 2007 057 401.2

(51) Int. Cl. B01D 53/14

(52) U.S. Cl. 95/36

(57) ABSTRACT

A method for the treatment of sorption medium in the treatment of smoke gas in brickworks is provided, in which smoke gas which has occurred during combustion is conducted through an exhaust air duct into which treated sorption medium, in particular limestone chips, is introduced. Treatment of the sorption medium involves introducing sorption medium into a mixer as initial material, the sorption medium being fresh material, partly saturated sorption material which has been recovered from the smoke gas, or a mixture of fresh and partly saturated sorption material. Additionally, a liquid, preferably water, is added to the sorption material directly in a mixer or before entering into the mixer.

### CROSS-REFERENCE TO RELATED APPLICATIONS

This applications claims the benefit of priority to German Patent Application No. 10 2007 057 401.2 filed Nov. 27, 2007, which is incorporated herein by reference in its entirety.

### FIELD OF THE INVENTION

The invention relates to a method for the treatment of sorption material used in the purification of smoke gas in brickworks. The method is suitable for the purification of smoke gases, which occur in industrial enterprises, in particular in brickworks. Smoke gas purification is necessary in order to absorb the gaseous impurities, for example, fluorine impurities.

### BACKGROUND OF THE INVENTION

According to the method of EP 1 205 233, a brickworks plant is designed such that part of the sorption material is disposed of, after being drawn off from the sorption container; a specific quantity of the partially saturated sorption material, which is still reactive, is mixed with an unsaturated sorption material, i.e., sorption material that has not yet been used. A calcareous material, for example, limestone chips enriched with water, is one such sorption material.

However, the mixing of the partly saturated sorption material with the unsaturated sorption material presents problems because the temperature of the partly saturated sorption material is relatively high, for example, around 200° C. Thus, in accordance with EP 1 205 233, the sorption material is cooled by means of a cooling assembly.

### SUMMARY

Such conventional methods have proved acceptable; however, there is the desire for a simplified method. Thus, the present invention provides a simplified method, wherein a liquid, for example, water, is added directly in a mixer, e.g., a mixing drum. Such a liquid addition operation, if appropriately assisted by the further addition of air, is sufficient to provide a water-enriched, powdery, warm sorption material which possesses high reactivity; the resulting sorption material can then be introduced directly into a smoke gas stream. This liquid is particularly useful when using a mixing drum to produce a stationary bed from the sorption material.

### BRIEF DESCRIPTION OF THE FIGURES

The invention is explained in more detail below with reference to the figure in which:

FIG. 1 shows a flow chart illustrating the set-up of a plant operating by a method according to the invention.

### DETAILED DESCRIPTION

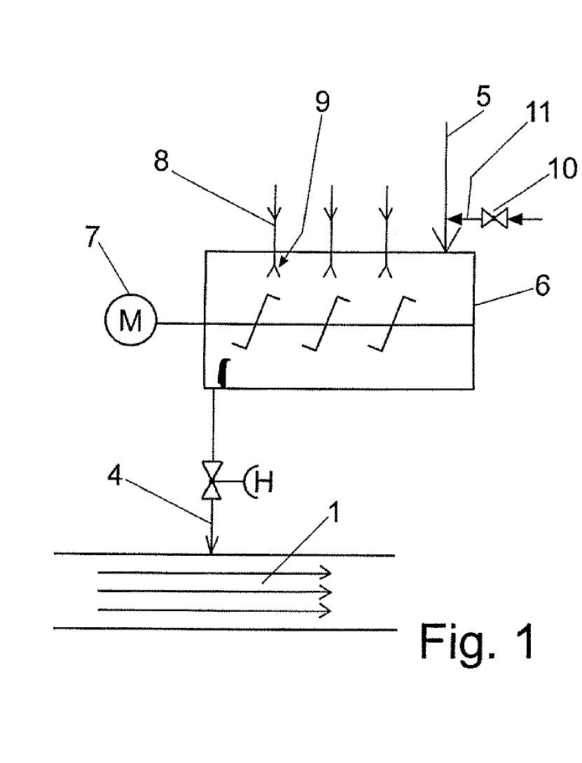

A smoke gas generator, for example, a kiln (not illustrated) may be used in a brickworks for baking bricks in a brickworks, which produces smoke gas. As illustrated in FIG. 1, a smoke gas 1 produced as a result of combustion is conducted through an exhaust air duct 2. A treated sorption medium 4, e.g., limestone chips, is introduced into the stream of smoke gas 1 by, for example injection via a valve 3.

The sorption medium is then treated as follows. Sorption medium 5 having a temperature of up to approximately 200° C. is introduced as: (1) an initial material, which is fresh material; (2) partly saturated sorption material that has been recovered from the smoke gas in a way not illustrated; or (3) a mixture of fresh and partly saturated sorption material, into a mixer which is preferably a rotating mixing drum 6 having a drive 7. A cooling assembly, which would conventionally precede the mixer is dispensed with.

A stationary fluidized bed is produced in the mixer. In order to obtain a certain degree of filling, a weir is mounted at the outflow. Water 8 is added in small quantities in steps to the fluidized bed by means of nozzles 9. Thus, the water addition takes place in steps, in order to avoid lumping in the sorption material and in order to allow water absorption.

Moreover, the fluidized bed is optionally aerated by means of fresh air 11, in order to avoid emerging vapors or lumping and to discharge again steam, which may possibly occur. Aeration preferably takes place by means of a valve 10 on the feed side. The air supplied is discharged into the smoke gas line, since the latter is under a vacuum.

According to the invention, therefore, liquid, in particular water, is added directly to the sorption medium in the mixer. The water-enriched powdery and warm sorption material is obtained in this way.

1. A method for the treatment of sorption medium in the treatment of smoke gas in brickworks, the method comprising:
introducing a sorption medium into a mixer as an initial material, the sorption medium being a fresh material, partly saturated sorption material which has been recovered from a smoke gas, or a mixture of fresh and partly saturated sorption material, and
adding a liquid to the sorption medium directly in a mixer or before entering the mixer.

2. The method of claim 1, further comprising mixing the sorption medium using a rotating mixing drum to produce a stationary fluidized bed.

3. The method of claim 2, wherein the fluid is added to the fluidized bed in steps.

4. The method of claim 2, wherein the fluid is added to the fluidized bed using nozzles.

5. The method of claim 2, further comprising aerating the fluidized bed.

6. The method of claim 5, wherein the air supplied for aeration is discharged into a smoke gas line, which is under a vacuum.

7. The method of claim 5, wherein the fluidized bed is aerated with fresh air.

8. The method of claim 6, wherein the fluidized bed is aerated via a valve on a feed side.

9. The method of claim 5, wherein the fluidized bed is aerated via a valve on a feed side.

10. The method of claim 5, wherein the air supplied for aeration is discharged into a smoke gas line, which is under a vacuum.
